(19) United States
(12) Patent Application Publication
(10) Pub. No.: US 2026/0235262 A1
(43) Pub. Date: Aug. 13, 2026

(54) METHOD FOR THE OPERATION OF A TANK UNIT FOR STORING A GASEOUS FUEL AND TANK UNIT FOR STORING A GASEOUS FUEL

(71) Applicant: Robert Bosch GmbH, Stuttgart (DE)

(72) Inventors: Stefan Kieferle, Stuttgart (DE); Birgit Lenz, Korntal (DE); Christian Kuhnert, Vaihingen/Enz (DE); Christian Schugger, Stuttgart (DE); Markus Strasser, Stuttgart (DE); Martin Schwab, Sindelfingen (DE); Nicolas Wussler, Esslingen Am Neckar (DE)

(21) Appl. No.: 19/149,143

(22) PCT Filed: Dec. 27, 2023
(86) PCT No.: PCT/EP2023/087854

§ 371 Date: Jul. 18, 2025

(30) Foreign Application Priority Data
Jan. 20, 2023 (DE) 10 2023 200 442.9

(51) Int. Cl. F17C 13/02

(52) U.S. Cl. CPC F17C 13/025; F17C 13/026; F17C 2205/0323; F17C 2250/043; F17C 2250/0439; F17C 2260/038

(57) ABSTRACT

The present invention relates to a method for operating a tank unit (1) for storing a gaseous fuel for a vehicle.

The invention also relates to a tank unit (1) for storing a gaseous fuel for a vehicle (F), comprising at least one tank vessel (TB1, TB2, ..., TBn) and at least one valve mechanism.

### BACKGROUND

The present invention relates to a method for the operation of a tank unit for storing a gaseous fuel and a tank unit for storing a gaseous fuel.

In known accumulator tanks, safety devices and/or valves can be installed. Fuel cell systems having tank assemblies or tanks for gaseous media are known for this purpose. In order to stabilize accumulator tanks upon an increase in the temperature of the storage medium or in the event of a leak, and to prevent or at least reduce a gas leak, they can be equipped with, for example, valves. However, it can also subsequently be desirable to obtain better knowledge of a tank level of tank units as well as leak in order to operate the vehicle and its fuel supply better in an operational state.

In conventional H2 tank systems with a plurality of gas tanks, each equipped with its own tank valve, not necessarily all tanks are equipped with their own pressure sensor.

DE112006003013B4 describes a tank with a fitting and a valve, wherein the valve is fastened in the fitting.

### SUMMARY

The present invention creates a method for the operation of a tank unit for storing a gaseous fuel and a tank unit for storing a gaseous fuel according to the disclosure.

The underlying concept of the present invention is to specify a method for the operation of a tank unit for storing a gaseous fuel and a tank unit for storing a gaseous fuel, wherein the localization and detection of leaks in a tank unit can be improved.

According to the invention, locating and detecting leaks in a high-pressure region and/or a mid-pressure region can be advantageously improved, wherein one or more tank vessels can belong to the high-pressure region. To this end, the one or more tank vessels can each comprise a temperature sensor.

According to the invention, in the method for the operation of a tank unit, the following occurs: shutting down a gas output from the mid-pressure region of the gas conduit system; detecting a first pressure in the high-pressure region by means of the first pressure sensor and first temperatures in the high-pressure region and a second pressure in the mid-pressure region by means of the second pressure sensor and second temperatures in the mid-pressure region; determining an average temperature in the mid-pressure region and an average temperature in the high-pressure region based on the determined first and second temperatures; determining a first comparative density in the high-pressure region based on the first pressure and the average temperature in the high-pressure region and a second comparative density in the mid-pressure region based on the second pressure and the average temperature in the mid-pressure region; re-detecting the first pressure, the first temperatures, the second pressure, and the second temperatures in the high-pressure region and the mid-pressure region prior to re-drawing gas from the mid-pressure region of the gas conduit; determining current averages of temperatures in the mid-pressure region and the high-pressure region from the re-detected first and second temperatures; determining a current density in the high-pressure region and the mid-pressure region from the current averages of temperatures and first and second pressures; and comparing the current density in the high-pressure region and the mid-pressure region to the respective comparative density and verifying a deviation between the respective current density and the comparative density in terms of a leak at the high-pressure region and/or the mid-pressure region according to a predetermined verification protocol.

The tank unit comprises at least one tank vessel having at least one valve mechanism; a gas conduit system to which the at least one tank vessel is connected via the valve mechanism; a first pressure sensor in a high-pressure region and a second pressure sensor in a mid-pressure region of the gas conduit system, wherein the respective tank vessel is connected to the high-pressure region of the gas conduit system and the high-pressure region is connected to the mid-pressure region by a control valve; and a control unit connected to the pressure sensors and the at least one valve mechanism.

With the method according to the invention, a leak on the tank unit can advantageously be detected during a downtime of the operation of the vehicle and/or consumer system. It can be advantageous to shut off a consumer of the gaseous fuel, in other words a valve towards the consumer and/or a valve on the tank vessel and towards the gas conduit system. In this case, for example, the consumer can be switched off (in the shut-off condition) and/or a valve on the anode side of a fuel cell, for example if the consumer corresponds to a fuel cell (here the so-called ASV, i.e. the anode block valve, can be closed).

It can be advantageous to assess the pressure sensor technology in the high-pressure region and the mid-pressure region and the temperature sensor technology in the tank vessel(s).

The wording of the respective tank vessel can also be replaced by “a tank vessel” or by “all tank vessels” within the meaning of the invention, likewise for the tank level.

The determination of the average temperatures can be done via the tank vessels and/or via selected points of the conduit system, i.e. temporally and/or spatially.

Thus, sensors (for pressure and temperature) can be present in the tank vessel and in the high-pressure region and/or the mid-pressure region, wherein temperature values can be retrieved. On the other hand, or in addition, ambient temperatures can also be determined, for example with a sensor, or via a model, or via data exchange with a data platform, wherein such a temperature determination can also apply to all other temperatures in and around the tank unit. The ambient temperature can be used in order to determine the density before re-opening the valves, for example when the system is equalized with the ambient temperature.

The comparative densities can also relate to an expected density at the respective operating point (for example, also during a downtime), taking into account the prevailing boundary conditions such as ambient temperatures or fill level, or others.

According to a preferred embodiment of the method, a pressure drop in the high-pressure region occurs after a closing of the valve mechanism between the gas conduit system and the at least one tank vessel before the gas consumption is stopped.

There can be advantageous targeted partial pressure reduction (pressure drop) in the high-pressure region before or during shutdown, which can be achieved, for example, by running the consumer after closing the valve mechanism on the tank vessel(s). Furthermore, or additionally, the temperature profile of the tank vessels and/or the conduit system (high-pressure and/or mid-pressure region) can then be determined over a predetermined downtime, wherein it can be possible to regularly wake up a control unit at defined intervals, and furthermore there can be a measuring and/or storing of the determined temperatures over a time of day and/or night.

Furthermore, or alternatively, temperature information can be provided via a data exchange platform, so-called “connected services,” taking into account the location of the vehicle. In this way, high-pressure and/or mid-pressure region temperatures can be determined by a model or by sensors, and an average temperature can be detected in the respective region.

According to a preferred embodiment of the method, the predetermined verification protocol relates to an increase in density in the high-pressure region, and a leak in the valve mechanism is inferred.

According to a preferred embodiment of the method, the predetermined verification protocol relates to a density reduction in the high-pressure region, and a leak in the high-pressure region is inferred, wherein, in the event of an additional increase in density in the mid-pressure region, an internal leak in the control valve between the high-pressure region and the mid-pressure region is inferred.

According to a preferred embodiment of the method, the predetermined verification protocol relates to an increase in density in the mid-pressure region, and a refilling or a leak at the control valve between the high-pressure region and the mid-pressure region is inferred.

According to a preferred embodiment of the method, the predetermined verification protocol relates to a reduction in density in the mid-pressure region, and a leak in the mid-pressure region is inferred, wherein, in the event of an additional change in density at an inlet of the consumer, a fault on the consumer is inferred, and, in the absence of a change in density at the inlet of the consumer, a leak at the mid-pressure region vis-à-vis a surrounding environment is inferred.

According to a preferred embodiment of the method, a determination of a pressure and temperatures in the high-pressure region and in the mid-pressure region is made by the pressure sensors and by temperature sensors in the high-pressure region and/or the mid-pressure region and/or by a temperature model for the high-pressure region and for the mid-pressure region over predetermined times and predetermined time intervals and/or information about an ambient temperature is determined by a data platform.

According to a preferred embodiment of the method, it is determined whether a pressure relief valve, which connects the mid-pressure region to the surrounding environment, was opened during a resting phase between stopping the gas drawing and starting the gas re-drawing, wherein a pressure profile and a temperature profile in the mid-pressure region are determined over predetermined times, and the resulting temperature profile is compared to temperature values and the determined pressure profile is compared to pressure values for triggering a pressure relief valve, and a prevailing condition for opening the pressure relief valve is inferred therefrom.

According to a preferred embodiment of the method, a normally expected density in the mid-pressure region is determined by determining a lowest temperature at the mid-pressure region during a predetermined period of time after stopping the gas drawing and before the gas re-drawing, as well as a pressure upon closing the control valve between the high-pressure region and the mid-pressure region.

According to a preferred embodiment of the method, an internal leak of the control valve between the high-pressure region and the mid-pressure region is detected when a density at the mid-pressure region is elevated compared to the normally expected density in the mid-pressure region.

According to a preferred embodiment of the method, the determination of an average temperature is performed using a temperature model.

The gas conduit can be used in order to supply the gaseous fuel to the tank vessels and also to remove the gas from the tank vessels towards the motor or fuel cell of the vehicle.

The valve mechanism can comprise a closable valve, which can be electrically opened and closed.

The vehicle can be a fuel cell vehicle. The gaseous fuel can be a gaseous gas for the operation of a fuel cell, for example hydrogen or also other gases that are possible for this purpose. On the other hand, the gaseous fuel can also be a gas for a gas-powered vehicle, such as CNG or LPG, which can also be liquid gas.

In vehicles with a fuel cell system, tank vessels filled with gaseous fuel can be present, wherein the tank vessel(s) can be under high pressure (up to approximately nominally 700 bar). During the downtime of a vehicle with an H2 storage system, different pressures can be set in the individual tanks. The cause for this is different temperature changes in the individual tanks, for example due to different heating or cooling due to different tank designs or different ambient boundary conditions on the tanks. These differences and effects on individual tanks can be considered.

The tank unit can also be characterized by the features mentioned in connection with the method and by the advantages of the method, and vice versa.

According to the present invention, the tank unit for storing a gaseous fuel for a vehicle comprises at least one tank vessel, having at least one valve mechanism;
a gas conduit system, to which the at least one tank vessel is connected via the valve mechanism; a first pressure sensor in a high-pressure region and a second pressure sensor in a mid-pressure region of the gas conduit system, wherein the respective tank vessel is connected to the high-pressure region of the gas conduit system and the high-pressure region is connected to the mid-pressure region by a control valve; a control unit connected to the pressure sensors and the at least one valve mechanism and configured so as to perform a method according to the invention.

A density determination can advantageously be carried out in the high-pressure region and in the mid-pressure region at a time after the consumer has been shut down. A pressure and a temperature in the high-pressure region can be measured for this purpose. Thereafter, an average temperature for the high-pressure region and/or for the mid-pressure region can be determined based on an existing sensor system and/or temperature model, which can happen, for example, taking into consideration gas temperatures, ambient temperature, or other ambient or operating parameters. In a further step, the gas densities for the high-pressure region and/or for the mid-pressure region can be saved or stored in the control unit (for example in the memory thereof) after shutdown. Furthermore, a re-determination of the density in the high-pressure region and/or the mid-pressure region can be performed at the time prior to opening the valves on the tank vessels or towards the consumer (at the next vehicle startup).

Furthermore, an assessment of the change in density in the high-pressure region and/or the mid-pressure region can be performed. With respect to the high-pressure region, a detected increase in density would lead to a leak of one or the valves (internal leak) being inferred, wherein, in conjunction with this inference, a targeted pressure reduction in the conduit system may be necessary. In the event of a detected reduction in density in the high-pressure region, a leak out of the high-pressure region (external leak) can be inferred, wherein a further assessment can then be carried out. For this further assessment, it can be determined whether there is leak in the high-pressure region without an increase in density in the mid-pressure region, which then indicates an external leak out of the high-pressure region (to the surrounding environment). On the other hand, it can then be determined if there is leak in the high-pressure region with an increase in density in the mid-pressure region, which then indicates an internal leak on the control valve between the high-pressure region and the mid-pressure region.

With respect to the mid-pressure region, it can be determined whether there is an increase in density in the mid-pressure region, which then indicates a refilling or a leak through the control valve. Furthermore, in the event of a reduction in density in the mid-pressure region, a leak from the mid-pressure region can be inferred, and a further assessment can then be carried out, wherein, if a leak is present in the mid-pressure region without a change in density or without a leak detection in the inlet region of a fuel cell (after the anode block valve ASV), an external leak from the mid-pressure region upstream of the fuel cell can be inferred. If a leak in the mid-pressure region can be detected with a change in density or leak detection in the region of the fuel cell, a fault on the fuel cell can be inferred.

Furthermore, a determination of a normally expected density (for the present operating point, for example with consideration of the present operating parameters on the system) can be made in the mid-pressure region, for example for a predetermined time or time period, for example without assuming an internal leak on the control valve. This can result from a closing pressure of the pressure regulator (control valve) and a lowest temperature during downtime, wherein a determination of the temperature profile in the high-pressure region and/or the mid-pressure region may be necessary. A case distinction can be made for this purpose.

If the density at the time before opening the valve on the tank vessel or towards the consumer corresponds to the normally expected density in the mid-pressure region at the next start-up of the consumer, there is probably no internal leak of the control valve, (only normal refilling is present), and the determined mass reduction in the high-pressure region corresponds to the mass increase in the mid-pressure region, then additionally the condition “no external leak in the high-pressure region and the mid-pressure region” can be inferred.

If the density at the time prior to opening the valves at the next start-up is increased compared to the “normally expected density in the mid-pressure region,” an internal leak of the control valve can be inferred. In this case, a computational assessment of the control valve leak can be performed, taking into account the change in density, the volume of the mid-pressure region (the change thereof) and a time since the lowest temperature.

If the density at the time before opening the valves at the next start-up corresponds to the “normally expected density in the mid-pressure region,” there is probably no internal leak of the control valve (only normal refilling), and the determined mass reduction in the high-pressure region can be greater than the mass increase in the mid-pressure region with a predetermined threshold. In this case, an “external leak from high-pressure region” can additionally be inferred.

If the density at the time prior to opening the valves at the next start-up is reduced compared to the “normally expected density in the mid-pressure region,” an external leak from the mid-pressure region can be inferred. In this case, there can be a computational assessment of an external leak, taking into account the change in density in the mid-pressure region and high-pressure region, mid-pressure region and high-pressure region volumes (their changes) and time since shutdown.

As a supplementary procedure for checking, it can be determined whether a pressure relief valve (PRV) had opened during downtime, wherein the determination of the temperature profile may be necessary for this step, and/or a temperature determination via data exchange of the connected services can be present.

It can be determined whether the density at the time prior to opening the valves (of the valve) is increased at the next start-up versus the “normally expected density in the mid-pressure region” and then an internal leak of the control valve can be inferred. For this purpose, a computational assessment of the maximum pressure during downtime can be carried out over the determined density in the mid-pressure region before start-up and the maximum temperature during downtime.

Then, a comparison of the maximum pressure during the downtime with a threshold for the minimum closing pressure of the pressure relief valve stored in the control unit can be carried out. To the extent that the calculated maximum pressure is greater than or equal to a threshold, an external leak may be inferred due to the PRV opening. Furthermore, a supplementary method for checking whether the PRV had been opened during downtime can be carried out, wherein it may be necessary to determine the temperature profile with the wake-up approach. In the wake-up approach, in addition to the temperature, the pressure in the mid-pressure region can also be measured. If one of the measured pressures is greater than or equal to the threshold, an external leak may be inferred due to the PRV opening.

The high-pressure region can be located in upstream of the control unit, towards the tank vessels. The mid-pressure region can be located between the control unit and the consumer, such as the fuel cell.

Further features and advantages of embodiments of the invention are apparent from the following description with reference to the accompanying drawing.

### BRIEF DESCRIPTION OF THE DRAWING

The present invention is explained in greater detail below with reference to the exemplary embodiment indicated in the figure of the drawing.

The following is shown:

FIG. 1 a schematic illustration of a tank unit for storing a gaseous fuel for a vehicle according to an exemplary embodiment of the present invention.

Identical reference signs in the figures denote identical or functionally identical elements.

### DETAILED DESCRIPTION

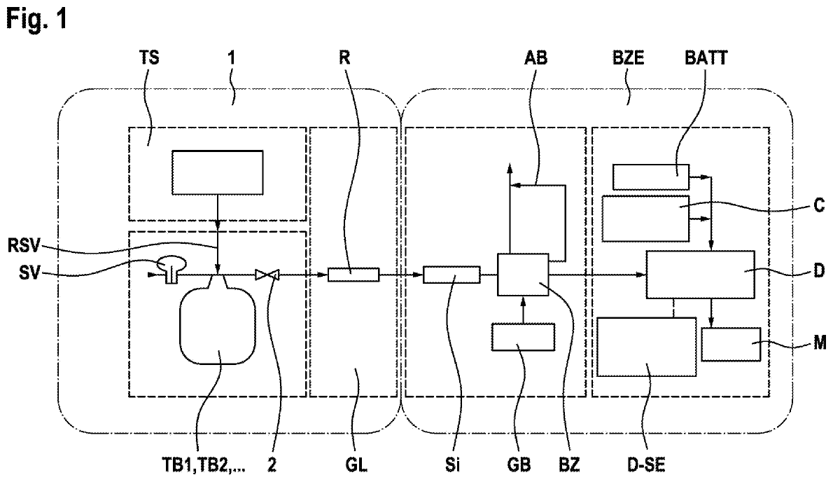

FIG. 1 shows a schematic illustration of a tank unit for storing a gaseous fuel for a vehicle according to an exemplary embodiment of the present invention.

The tank unit 1 comprises at least one tank vessel (TB1, TB2, ..., TBn) having at least one valve mechanism; a gas conduit system GL to which the at least one tank vessel (TB1, TB2, ..., TBn) is connected via the valve mechanism; a first pressure sensor in a high-pressure region and a second pressure sensor in a mid-pressure region of the gas conduit system GL, wherein the respective tank vessel (TB1, TB2, ..., TBn) is connected to the high-pressure region of the gas conduit system GL and the high-pressure region is connected to the mid-pressure region by a control valve; a control unit connected to the pressure sensors and the at least one valve mechanism and configured so as to perform a method according to the invention. The following occurs in the method: shutting down a gas output from the mid-pressure region of the gas conduit system; detecting a first pressure in the high-pressure region by means of the first pressure sensor and first temperatures in the high-pressure region and a second pressure in the mid-pressure region by means of the second pressure sensor and second temperatures in the mid-pressure region; determining an average temperature in the mid-pressure region and an average temperature in the high-pressure region based on the determined first and second temperatures; determining a first comparative density in the high-pressure region based on the first pressure and the average temperature in the high-pressure region and a second comparative density in the mid-pressure region based on the second pressure and the average temperature in the mid-pressure region; re-detecting the first pressure, the first temperatures, the second pressure, and the second temperatures in the high-pressure region and the mid-pressure region prior to re-drawing gas from the mid-pressure region of the gas conduit; determining current averages of temperatures in the mid-pressure region and the high-pressure region from the re-detected first and second temperatures; determining a current density in the high-pressure region and the mid-pressure region from the current averages of temperatures and first and second pressures; and comparing the current density in the high-pressure region and the mid-pressure region to the respective comparative density and verifying a deviation between the respective current density and the comparative density in terms of a leak at the high-pressure region and/or the mid-pressure region according to a predetermined verification protocol.

FIG. 1 shows a system from a hydrogen storage tank having a tank unit 1 and a fuel cell device BZE.

The plurality of tank vessels TB1, TB2, ... are symbolically shown as one tank, which can be connected to a safety valve SV, for example a thermally actuated safety valve, and to a shut-off valve 2. A tank side TS (for example, towards a gas station) can be connected to the tank TB1, ... by means of a check valve RSV. The shut-off valve can be connected to the fuel cell BZ in the fuel cell device BZE by means of a control unit R, in particular via a gas conduit GL. The gas conduit GL itself can comprise the sensor Si on the high-pressure side, i.e. in the flow direction upstream of the control unit, wherein the side on the fuel cell, i.e. downstream of the control unit R, can also comprise such a pressure and/or temperature sensor Si. The fuel cell BZ can be connected to a fan GB and to an exhaust region AB. The fuel cell can subsequently power an energy management system D, such as with a battery Batt, one or more capacitors C, an associated control unit D-SE, and a motor M. The high-pressure region can be located upstream of the control unit R towards the tank vessels. The mid-pressure region can be located between the control unit R and the consumer, such as the fuel cell.

Although the present invention has been described in full with reference to the preferred embodiment, it is not limited thereto and can be modified in many ways.

1. A method for the operation of a tank unit (1) for storing a gaseous fuel for a vehicle, wherein the tank unit (1) comprises:
at least one tank vessel (TB1, TB2, ..., TBn) having at least one valve mechanism;
a gas conduit system (GL) to which the at least one tank vessel (TB1, TB2, ..., TBn) is connected via the valve mechanism;
a first pressure sensor in a high-pressure region and a second pressure sensor in a mid-pressure region of the gas conduit system (GL), wherein the respective tank vessel (TB1, TB2, ..., TBn) is connected to the high-pressure region of the gas conduit system (GL) and the high-pressure region is connected to the mid-pressure region by a control valve; and
a control unit connected to the pressure sensors and the at least one valve mechanism; the method comprising the steps of:
shutting down a gas output from the mid-pressure region (MD) of the gas conduit system (GL);
detecting a first pressure in the high-pressure region by means of the first pressure sensor and first temperatures in the high-pressure region and a second pressure in the mid-pressure region by means of the second pressure sensor and second temperatures in the mid-pressure region;
determining an average temperature in the mid-pressure region and an average temperature in the high-pressure region based on the determined first and second temperatures;
determining a first comparative density in the high-pressure region based on the first pressure and the average temperature in the high-pressure region and a second comparative density in the mid-pressure region based on the second pressure and the average temperature in the mid-pressure region;
re-detecting the first pressure, the first temperatures, the second pressure, and the second temperatures in the high-pressure region and the mid-pressure region prior to re-drawing gas from the mid-pressure region of the gas conduit;
determining current averages of temperatures in the mid-pressure region and the high-pressure region from the re-detected first and second temperatures;
determining a current density in the high-pressure region and the mid-pressure region from the current averages of temperatures and first and second pressures; and
comparing the current density in the high-pressure region and the mid-pressure region to the respective comparative density and verifying a deviation between the respective current density and the comparative density in terms of a leak at the high-pressure region and/or the mid-pressure region according to a predetermined verification protocol.

2. The method according to claim 1, in which a pressure drop in the high-pressure region occurs after a closing of the valve mechanism between the gas conduit system and the at least one tank vessel before the gas consumption is stopped.

3. The method according to claim 2, in which the predetermined verification protocol relates to an increase in density in the high-pressure region, and a leak in the valve mechanism is inferred.

4. The method according to claim 1, in which the predetermined verification protocol relates to a density reduction in the high-pressure region, and a leak in the high-pressure region is inferred, wherein, in the event of an additional increase in density in the mid-pressure region, an internal leak in the control valve between the high-pressure region and the mid-pressure region is inferred.

5. The method according to claim 1, in which the predetermined verification protocol relates to an increase in density in the mid-pressure region, and a refilling or a leak at the control valve between the high-pressure region and the mid-pressure region is inferred.

6. The method according to claim 1, wherein the predetermined verification protocol relates to a reduction in density in the mid-pressure region, and a leak in the mid-pressure region is inferred, wherein, in the event of an additional change in density at an inlet of the consumer, a fault on the consumer is inferred, and, in the absence of a change in density at the inlet of the consumer, a leak at the mid-pressure region vis-à-vis a surrounding environment is inferred.

7. The method according to claim 1, in which a determination of a pressure and temperatures in the high-pressure region and in the mid-pressure region is made by the pressure sensors and by temperature sensors in the high-pressure region and/or the mid-pressure region and/or by a temperature model for the high-pressure region and for the mid-pressure region over predetermined times and predetermined time intervals and/or information about an ambient temperature is determined by a data platform.

8. The method according to claim 1, in which it is determined whether a pressure relief valve, which connects the mid-pressure region to the surrounding environment, was opened during a resting phase between stopping the gas drawing and starting the gas re-drawing, wherein a pressure profile and a temperature profile in the mid-pressure region are determined over predetermined times, and the resulting temperature profile is compared to temperature values and the determined pressure profile is compared to pressure values for triggering a pressure relief valve, and a prevailing condition for opening the pressure relief valve is inferred therefrom.

9. The method according to claim 7, in which a normally expected density in the mid-pressure region is determined by determining a lowest temperature at the mid-pressure region during a predetermined period of time after stopping the gas drawing and before the gas re-drawing, as well as a pressure upon closing the control valve between the high-pressure region and the mid-pressure region.

10. The method according to claim 8, in which an internal leak of the control valve between the high-pressure region and the mid-pressure region is detected when a density at the mid-pressure region is elevated compared to the normally expected density in the mid-pressure region.

11. The method according to claim 1, wherein the determination of an average temperature is performed using a temperature model.

12. A tank unit (1) for storing a gaseous fuel for a vehicle (F), comprising:
at least one tank vessel (TB1, TB2, ..., TBn) having at least one valve mechanism;
a gas conduit system (GL) to which the at least one tank vessel (TB1, TB2, ..., TBn) is connected via the valve mechanism;
a first pressure sensor in a high-pressure region and a second pressure sensor in a mid-pressure region of the gas conduit system (GL), wherein the respective tank vessel (TB1, TB2, ..., TBn) is connected to the high-pressure region of the gas conduit system (GL) via the valve mechanism and the high-pressure region is connected to the mid-pressure region by a control valve;
a control unit connected to the pressure sensors and the at least one valve mechanism and configured to
shut down a gas output from the mid-pressure region (MD) of the gas conduit system (GL);
detect a first pressure in the high-pressure region by means of the first pressure sensor and first temperatures in the high-pressure region and a second pressure in the mid-pressure region by means of the second pressure sensor and second temperatures in the mid-pressure region;
determine an average temperature in the mid-pressure region and an average temperature in the high-pressure region based on the determined first and second temperatures;
determine a first comparative density in the high-pressure region based on the first pressure and the average temperature in the high-pressure region and a second comparative density in the mid-pressure region based on the second pressure and the average temperature in the mid-pressure region;
re-detect the first pressure, the first temperatures, the second pressure, and the second temperatures in the high-pressure region and the mid-pressure region prior to re-drawing gas from the mid-pressure region of the gas conduit;
determine current averages of temperatures in the mid-pressure region and the high-pressure region from the re-detected first and second temperatures;
determine a current density in the high-pressure region and the mid-pressure region from the current averages of temperatures and first and second pressures; and
compare the current density in the high-pressure region and the mid-pressure region to the respective comparative density and verifying a deviation between the respective current density and the comparative density in terms of a leak at the high-pressure region and/or the mid-pressure region according to a predetermined verification protocol.

13. The tank unit (1) according to claim 12, in which the control unit is configured to be connected to a fuel cell of the vehicle and is configured so as to determine from the fuel cell a necessary gas consumption for a generated power of the fuel cell.

14. The tank unit (1) according to claim 12, which comprises a plurality of temperature sensors in the high-pressure region and one or more temperature sensors in the mid-pressure region.
